(19) United States
(12) Patent Application Publication
(10) Pub. No.: US 2015/0040662 A1
(43) Pub. Date: Feb. 12, 2015

(54) APPARATUS FOR DETECTING ROTATIONAL SPEED AND METHOD FOR MANUFACTURING SAME

(71) Applicant: DENSO CORPORATION, Kariya-city (JP)

(72) Inventor: Mitsuru Takasaki, Obu-city (JP)

(21) Appl. No.: 14/326,696

(22) Filed: Jul. 9, 2014

(30) Foreign Application Priority Data
Aug. 6, 2013 (JP) 2013-163510

(51) Int. Cl. G01P 1/00

(52) U.S. Cl. CPC G01P 1/006
USPC 73/497

(57) ABSTRACT

An apparatus for detecting rotational speed includes a lead wire having a signal line covered with a sheath layer and a rotational speed detector connected to the lead wire and outputting an electrical signal corresponding to an object rotation. The apparatus for detecting rotational speed further includes a housing having the rotational speed detector inside and a resin stay integrally holding the housing and the lead wire. The resin stay includes at least one hole formed thereon.

### CROSS REFERENCE TO RELATED APPLICATION

This application is based on Japanese Patent Application No. 2013-163510 filed on Aug. 6, 2013, the disclosure of which is incorporated herein by reference.

### TECHNICAL FIELD

The present disclosure relates to an apparatus for detecting rotation and a method for manufacturing the same, especially for cost reduction.

### BACKGROUND

An example of a rotational speed sensor for detecting wheel speed is disclosed in JP-2004-257867A. In this sensor, a resin stay integrally holds a lead wire and a housing including a detector element inside.

The lead wire includes a signal line covered with a sheath layer. In a production process of molding the resin stay, the sheath layer is heated at a high temperature by a molten resin forming the resin stay. For that reason, the lead wire must employ a high heat resistance material, such as cross-linkable resin, as the sheath layer. Consequently, the rotational speed detector could be expensive due to cost of the lead wire.

### SUMMARY

It is an object of the present disclosure to produce an apparatus for detecting rotational speed with a lead wire capable of a low heat resistance layer and to manufacture the same.

It is therefore an aspect of the present disclosure to provide an apparatus for detecting rotational speed. The apparatus includes a lead wire having a signal line covered with a sheath layer, a rotation detector connected to the lead wire and outputting an electrical signal corresponding to an object rotation, a housing having the rotation detector inside, and a resin stay integrally holding the housing and the lead wire. The resin stay includes at least one hole formed thereon.

Another aspect of the present disclosure is to provide a method for manufacturing the apparatus for detecting rotational speed. The method includes a placing process which includes arranging a thermal radiation pin in a metal molding die in which the detector and the lead wire connected electrically to each other are set therein, and a stay molding process. The thermal radiation pin is made of metal including a portion corresponding to the at least one hole and having a higher thermal conductivity than the resin stay, and the stay molding process includes molding the resin stay by injecting a molten resin into the metal molding die after the placing process. The resin stay is made of the molten resin.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing a rotational speed detector as an embodiment of the present disclosure;

FIG. 2 is a cross-sectional view showing a rotational speed detector shown in FIG. 1, taken along a plane including a shaft center of a lead wire;

FIG. 3 is a schematic diagram showing a housing containing an end of the lead wire;

FIG. 4 is a diagram showing a manufacturing process of the rotationally speed detector;

FIGS. 5A and 5B are diagrams showing the arrangement of thermal radiation pins in a placing process; and

FIG. 6 is a schematic diagram showing another rotational speed detector of the present disclosure, different from the one shown in FIG. 1.

### DETAILED DESCRIPTION

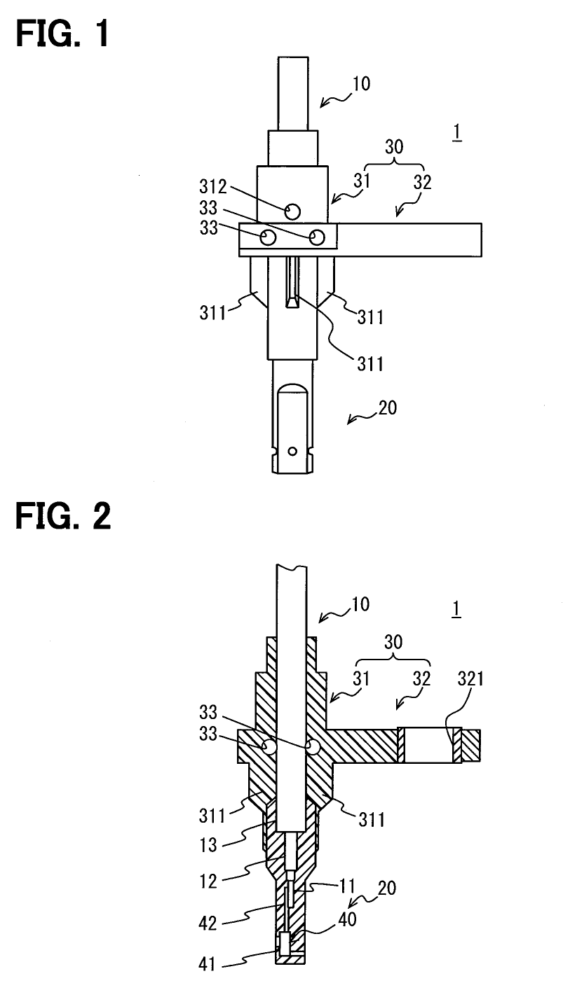

An embodiment of the disclosure is described referring to the drawings. An outline view of FIG. 1 shows a rotational speed sensor 1 including a lead wire 10, a housing 20, and a stay 30.

As shown in a cross-sectional view of FIG. 2, the lead wire 10 includes a signal line 11 inside, which is made of metal. The signal line 11 is covered with a shield layer 12 on the peripheral surface thereof. Only one signal line 11 is drawn in FIG. 2, but the lead wire 10 actually includes two signal lines 11 integrally covered with the shield layer 12. The shield layer 12 is further covered with a sheath layer 13 on the peripheral surface thereof. The sheath layer 13 is made of non-cross-linkable resin, such as non-cross-linkable polyurethane.

At an end portion of the lead wire 10, the signal line 11 is exposed from the sheath layer 13 and the shield layer 12. An end portion of the sheath layer 13 and both of exposed portions of the shield layer 12 and the signal line 11 are contained in a housing 20.

The housing 20, which is made of resin, covers and holds the rotational speed detector 40 unmovably at an end thereof. The rotational speed detector 40 includes a main body 41 having a sensor element and a processor (not shown in FIGs) and a lead frame 42 protruding from the main body 41. An end portion of the lead frame 42 is electrically connected to the signal line 11.

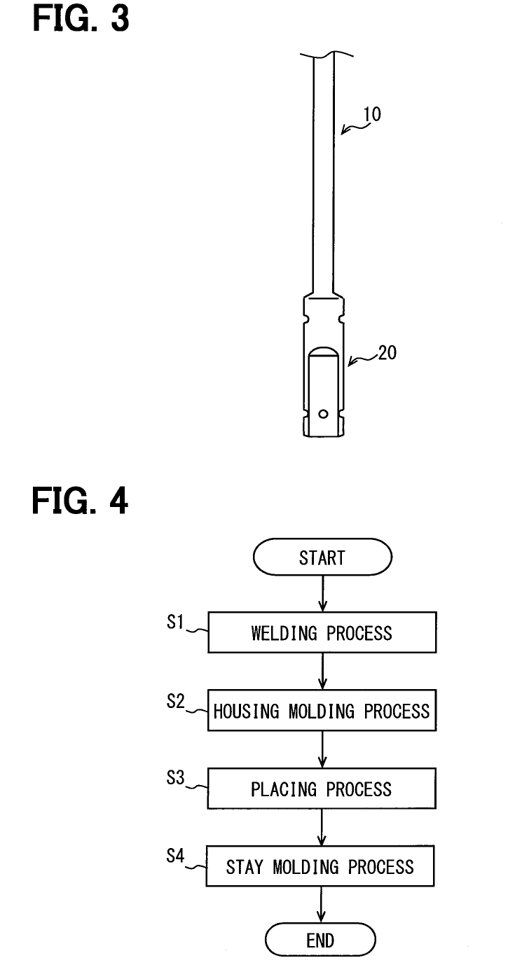

FIG. 3 illustrates that the end of the lead wire 10 is contained in the housing 20. This arrangement is made after the lead frame 42 and the end of the signal line 11 are welded to each other and are contained by the housing 20.

As shown in FIG. 1 and FIG. 2, the stay 30 includes a holding portion 31 that integrally holds the lead wire 10 and the housing 20. The stay 30 further includes a mounting portion 32 that is mounted on a designated mount space, such as a wheel hub. The holding portion 31 and the mounting portion 32 are integrally formed with an injection molding method.

The holding portion 31 has a substantially cylindrical shape and covers both of an end portion of the housing 20 adjacent to the lead wire 10 and an end portion of the lead wire 10. The mounting portion 32 protrudes in an outer radial direction from near a shaft center of the holding portion 31. The mounting portion 32 has a planer shape and a collar 321 fixed at the end thereof. A fixing bolt, not shown in FIG. 3, inserts into the collar 321 to fix the rotational speed sensor 1 on the designated mount space.

The holding portion 31 has a plurality of ribs 311 that protrudes in the outer radial direction adjacent to the mounting portion 32 on a side of the housing 20. In this embodiment, four ribs 311 are arranged in a circumferential direction at even intervals.

As shown in FIG. 1, the holding portion 31 further includes a bottom hole 312 formed on a side opposing to the ribs 311 by with the mounting portion 32 there between. Only one bottom hole 312 is drawn in FIG. 1, but actually, another bottom hole 312 is also formed behind the lead wire 10 opposing to the bottom hole 312 shown in FIG. 1. In this embodiment, namely, two bottom holes 312 are formed.

These two bottom holes 312 penetrates toward an inner surface of the holding portion 31 in an inner radial direction. Since the holding portion 31 has a cylindrical shape and holds the lead wire 10 inside, a bottom of the bottom hole 312 is a cylindrical outer surface of the sheath layer 13. Alternatively, the bottom of the bottom hole 312 may be positioned at a greater distance than a diameter of the lead wire 10.

In addition to the two bottom holes 312, a pair of through holes 33 penetrates through both the holding portion 31 and the mounting portion 32. In other words, the pair of through holes 33 penetrate through the stay 30. The pair of through holes 33 are oriented generally parallel to each other.

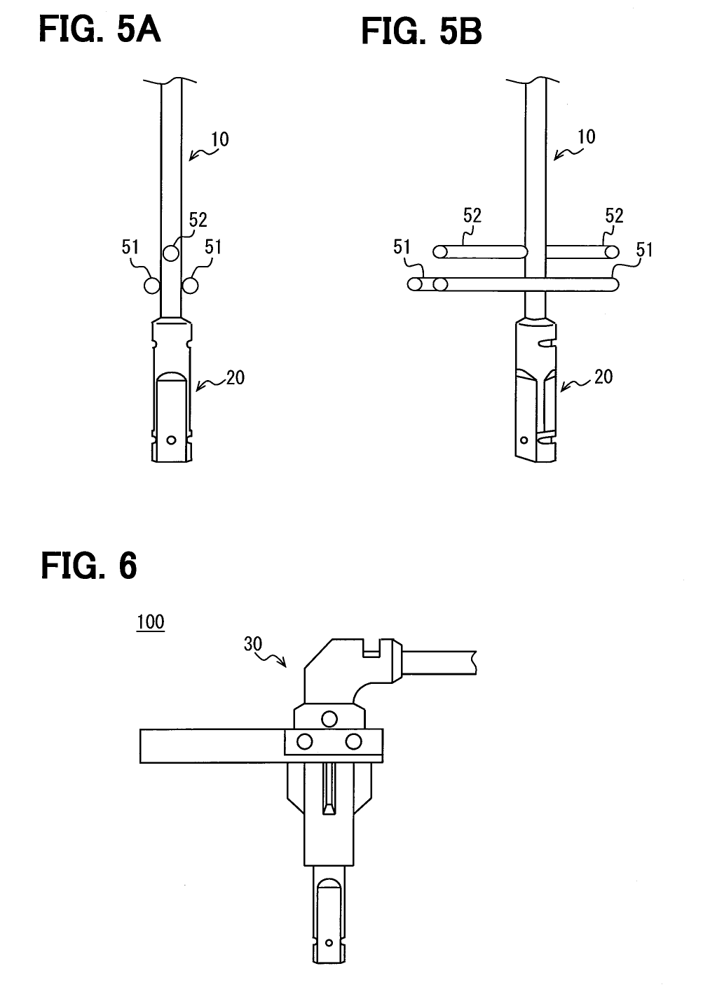

As shown in FIG. 2, the pair of through holes 33 are formed adjacent to the lead wire 10 in a molding process of the stay 30. That is why, as shown in FIGS. 5A and 5B, thermal radiation pins 51 and 52 limit a position of the lead wire 10 in the left-to-right direction in FIG. 2 and form the pair of through holes 33. Therefore, the pair of through holes 33 are formed within a distance from the lead wire 10 to allow the lead wire 10 to be moveable. For example, a distance between the lead wire 10 and each of the pair of through hole 33 may be equal to or less than a diameter of the lead wire 10. More preferably, the distance may be less than a radius of the lead wire 10. However, the pair of through holes 33 may not have to be adjacent to the lead wire 10 in the point of view of a thermal radiation. Thus, the pair of through holes 33 are not limited to be positioned as shown in FIG. 2 and may be positioned where the thermal radiation pins 51 are possibly set.

As described above, the bottom hole 312 is formed adjacent to the mounting portion 32. The pair of through holes 33 are formed to penetrate through both of the holding portion 31 and the mounting portion 32. Namely, the bottom hole 312 and the pair of through holes 32 are adjacent to each other.

In the rotational speed sensor 1 described above, the rotational speed detector 40 outputs an electrical signal according to a wheel rotation under a condition that the rotational speed sensor 1 is mounted on the designated mount space. The electrical signal is input to a signal processor (not shown) via the signal line 11.

### Method for Manufacturing the Rotational Speed Sensor 1

Next, a method for producing the rotational speed sensor 1 is descried with reference to FIG. 4. In a welding process in step S4, the lead frame 42 and the end of the signal line 11 are welded to each other. Various known welding methods may be applied to the welding process, such as, electric resistor welding, ultrasonic welding and soldering, for example.

In a housing molding process in step S2, the housing 20 is formed. Various known molding methods are applied to the housing molding process, such as injection molding and compression melding, for example. A runner, which a molten resin such as epoxy resin is flowed out therefrom, is set near to a central portion of the housing 20 in the injection molding. The runner also may be set closer to the end of the housing 20 than the central portion of the housing 20. Alternatively, the runner also may be set on a side of the lead wire 10 rather than the central portion of the housing 20.

In a placing process in step S3, a molded body molded in the housing molding process is clamped within a molding die (not shown) to form the stay 30. In addition, the thermal radiation pins 51 and 52 are arranged in the molding die corresponding to positions of the bottom hole 312 and the pair of through holes 33.

FIGS. 5A and 5B show an arrangement of the thermal radiation pins 51 and 52. In this embodiment, a total of four holes, including the bottom hole 312 and the pair of through holes 312, are formed. Thus, four thermal radiation pins 51 and 52 are arranged. The four thermal radiation pins 51 and 52 are made of metal having a high thermal conductivity and high thermal resistance.

A pair of thermal radiation pins 51 form the pair of through holes 33. As shown in FIG. 5A, the pair of thermal radiation pins 51 are arranged with the lead wire 10 between circumference surfaces thereof in parallel to each other.

On the other hand, a pair of thermal radiation pins 52 form the bottom holes 312. As shown in FIG. 5B, the pair of thermal radiation pins 52 are arranged with the lead wire between each end surfaces thereof in a substantially straight line.

In this embodiment, each of the thermal radiation pins 51 and 52 have a circular cross section. As shown in FIGS. 5A and 5B, four thermal radiation pins 51 and 52 are parallel to each other. The thermal radiation pins 51 with the lead wire 10 there between, limit a position of the lead wire 10 on a planer surface including the pair of the thermal radiation pins 51 in a radial direction of the thermal radiation pins 51. The thermal radiation pins 52 with the lead wire 10 there between, limit a position of the lead wire 10 in an axial direction of the thermal radiation pins 52. According to a formation of four thermal radiation pins 51 and 52 as shown in FIGS. 5A and 5B, a movement of the lead wire 10 within an area clamped by the thermal radiation pins 51 and 52 is restrained in both of a radial and an axial direction.

In the stay molding process in step S4, a molten resin such as polybutylene terephthalate, which the stay comprises, is injected to the molding die under the condition that the movement of the lead wire 10 is restrained. A gate, which the molten resin is injected from, is positioned corresponding to a tip end of the mounting portion 32. Therefore, the molten resin flows in a stay molding portion formed on the molding die from the tip end to a base end of the mounting portion 32 and then flows from the base end to a both sides of the holding portion 31.

After a cooling solidification of the molten resin, the rotational speed sensor 1 is finished by removing the molded body from the molding die and by attaching the collar 312 to the mounting portion 32.

According to the embodiment described above, a total of four holes consisting of two through holes 33 and two bottom holes 312 are formed on the stay 30 made of resin. In the placing process in step S3, the thermal radiation pins 51 and 52 are arranged in the molding die and form holes 33 and 312. The thermal radiation pins 51 and 52 are made of metal, having a higher thermal conductivity than the stay 30 made of resin. In the stay molding process S4, therefore, the thermal radiation pins 51 and 52 radiate heat of the molten resin quickly. Especially, the thermal radiation pins 51 have high efficiency at thermal radiation because the thermal radiation pins 51 extend to both sides of the pair of through holes 33.

These four thermal radiation pins 51 and 52 suppress increasing temperature of the sheath layer 13. Therefore, thermostability required to the sheath layer 13 can be lowered. As a result, an inexpensive lead wire 10 with a sheath layer having low thermal resistance can be utilized.

In this embodiment, both of the through holes 33 and the bottom holes 312 are formed near or on a base where the mounting portion 32 protrudes. Both of the through holes 33 and the bottom holes 312 may also be formed within a distance away from the base in an axial direction, which the distance is corresponding to a thickness of the mounting portion 32 for example.

The gate, which the molten resin is injected therefrom and forms the stay 30, is formed at a portion corresponding to the tip end of the mounting portion 32. Therefore, the boundary between the holding portion 31 and the mounting portion 32 is made closest to the gate and the hottest in the holding portion 31. In this embodiment, four thermal radiation pins 51 and 52 including portions corresponding to the through holes 33 and bottom holes 312 are arranged near the boundary. Thus, the heat of the molten resin is radiated especially quickly.

In this embodiment, the pair of through holes 33 and the pair of bottom holes 312 are formed on the stay 30. In the stay molding process S4, both of one pair of thermal radiation pins 51 and another pair of thermal radiation pins 52 put the lead wire 10 each there between. Therefore, the thermal radiation pins 51 and 52 restrain the movement of the lead wire 10 during the stay molding process S4.

Specifically, the one pair of thermal radiation pins 51 and the another pair of thermal radiation pins 52 are arranged to restrain the movement of the lead wire 10 in outer radial directions perpendicularly intersecting to each other. Therefore, the stay 30 is molded with the lead wire 10 at a specific position.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

### First Variant Embodiment

The above-described embodiment employs the thermal radiation pins 51 and 52 each having the circular cross section. Alternatively, the cross section may be elliptic, rectangular, or others.

### Second Variant Embodiment

As shown as the rotational speed sensor 100 in FIG. 6, the base of the stay 30 may be bent against the end portion.

### Other Variant Embodiments

In the previous embodiments, a total of four holes consisting of two through holes 33 and two bottom holes 312 are formed on the stay 30. Alternatively, only one of the through holes 33 and the bottom holes 312 may be formed (Third variant embodiment). The number of the holes is not limited to the number described in the previous embodiments regardless of hole types (through or bottom). For example, the number of holes could be only one (Fourth variant embodiment). Since it is not strongly necessary to have the pair of through holes 33 or the pair of bottom holes 312, the movement of the lead wire 10 does not have to be restrained by the thermal radiation pins 51 and 52 during the stay molding process S4 (Fifth variant embodiment). The positions of the holes 33 and 312 are not limited to the positions described in the previous embodiments and may be formed in a distant portion from the base where the mounting portion 32 protrudes (Sixth variant embodiment). This invention may be applied for detecting rotational speed other than detecting wheel speed, such as detecting rotational speed of devices included in transmissions, engines, or others.

What is claimed is:

1. An apparatus for detecting rotational speed, comprising:
a lead wire having a signal line covered with a sheath layer;
a rotational speed detector connected to the lead wire and outputting an electrical signal corresponding to an object rotation;
a housing having therein the rotational speed detector; and
a resin stay integrally holding the housing and the lead wire, wherein
the resin stay includes at least one hole formed thereon.

2. The apparatus for detecting rotational speed according to claim 1, wherein the sheath layer is made of non-cross-linkable resin.

3. The apparatus for detecting rotational speed according to claim 1, wherein the at least one hole includes at least one through hole penetrating through the resin stay.

4. The apparatus for detecting rotational speed according to claim 3, wherein the at least one through hole includes two through holes adjacent to the lead wire with the lead wire there between at opposite sides to each other.

5. The apparatus for detecting rotational speed according to claim 1, wherein the at least one hole includes a bottom hole bottomed by an outer surface of the sheath layer.

6. The apparatus for detecting rotational speed according to claim 4 further comprising:
two bottom holes bottomed by an outer surface of the sheath layer,
wherein the two bottom holes oppose each other in the same direction as the through hole and put the lead wire there between.

7. The apparatus for detecting rotational speed according to claim 1, wherein
the resin stay further includes a holding portion and a mounting portion, the holding portion holds the lead wire and the housing, and the mounting portion protrudes in an outer radial direction from the holding portion to be mounted on a designated mount space; and
the at least one hole is formed near the holding portion where the mounting portion protrudes.

8. A method for manufacturing the apparatus for detecting rotational speed according to claim 1, the method comprising:
a placing process which includes arranging a thermal radiation pin in a metal molding die in which the detector and the lead wire connected electrically to each other are set, the thermal radiation pin is made of metal including a portion corresponding to the at least one hole and having a higher thermal conductivity than the resin stay; and
a stay molding process which includes molding the resin stay by injecting a molten resin into the metal molding die after the placing process, wherein the resin stay is made of the molten resin.
